(19) United States
(12) Patent Application Publication
(10) Pub. No.: US 2016/0329732 A1
(43) Pub. Date: Nov. 10, 2016

(54) BATTERY UNIT, INFORMATION PROCESSING DEVICE, AND METHOD FOR CONTROLLING BATTERY UNIT

(71) Applicant: FUJITSU LIMITED, Kawasaki-shi (JP)

(72) Inventors: Michio Koyama, Minato (JP); Masaharu Yamada, Machida (JP); Daisuke Yuzawa, Fuchu (JP)

(21) Appl. No.: 15/213,865

(22) Filed: Jul. 19, 2016

Related U.S. Application Data
(63) Continuation of application No. PCT/JP2014/051297, filed on Jan. 22, 2014.

(51) Int. Cl. H02J 7/00

(52) U.S. Cl. CPC H02J 7/0054; H02J 2007/006; H02J 2007/0059

(57) ABSTRACT

A bay battery cell is charged at voltage for driving a personal computer. A USB port is a terminal that is connectable with an external device that is different from the personal computer and supplies power to the external device. A DC-DC converter receives a power input from the bay battery cell, converts the input power into voltage for driving the external device, and supplies the converted power to the external device through the USB port. A switch control circuit drives the DC-DC converter when no power is supplied from the personal computer and no external devices are connected to the USB port.

### CROSS-REFERENCE TO RELATED APPLICATIONS

This application is a continuation of International Application No. PCT/JP2014/051297, filed on Jan. 22, 2014, the entire contents of which are incorporated herein by reference.

### FIELD

The embodiment discussed herein is related to a battery unit, an information processing device, and a method for controlling a battery unit.

### BACKGROUND

Information processing devices, such as a notebook personal computer and a digital camera, are widely used that are connectable with a power supply device such as a battery that is capable of supplying power and charging and with a power supply device such as an alternating current (AC) adaptor that is capable of supplying power. The battery is charged by the power supplied from the AC adaptor.

More notebook personal computers now have a plurality of batteries. For example, as one of those batteries, notebook personal computers have a main battery installed as a part of the computer. Other than the main battery, such notebook personal computers may have a sub-battery as an auxiliary battery. Specifically, notebook personal computers have an expansion bay serving as an empty space for additionally installing therein a digital versatile disc (DVD) drive, a hard disk, and others. Furthermore, some notebook personal computers can install an additional battery used as a sub-battery in the expansion bay. Such a sub-battery stored in the bay may be referred to as a “bay battery”.

Sub-batteries with easy detachability are likely to be used as a power supply not only to the personal computer but to other devices in case of emergency such as disaster. For example, use of the sub-battery as a power supply for charging a mobile phone is considered as important usage.

Considering use of the sub-battery as a power supply to devices other than personal computers, some conventional techniques provide the sub-battery with a connecting terminal, for example, a universal serial bus (USB), for connecting the battery with other devices.

When the sub-battery is detached from a notebook personal computer and used as a power supply in emergency situations, it is desirable that the sub-battery be in fully charged.

It is thus preferable to control unnecessary power consumption in order to maintain the sub-battery fully charged. For controlling power consumption in the charging circuit, some conventional techniques provide the sub-battery with a mechanical switch so that the operator can turn on and off the power supply to the charging circuit.

Furthermore, as a technique to control power consumption of a battery, some conventional techniques relating to a battery of a mobile terminal or the like describe such a method that cuts off power supply to a charging circuit, a communication circuit, and others when the battery is not connected to the device. Conventional methods are described in Japanese Laid-open Patent Publication No. 2013-51797 and No. 2012-143039.

However, the above-described mechanical switch is manually turned on and off by the operator. Unless the operator appropriately turns on and off the switch, it is difficult to reduce waste of power consumption.

Such conventional techniques that enable power consumption to be reduced when the battery is unconnected to the personal computer fail to reduce power consumption when the battery is connected with the computer. When the battery is detached from the computer, the charging level of the battery may be insufficiently low.

### SUMMARY

According to an aspect of an embodiment, a

battery unit includes: a first battery that is charged at voltage for driving an information processing device; an output terminal that is connectable with an external device different from the information processing device and supplies power to the external device; a converter that receives a power input from the first battery, converts the input power into voltage for driving the external device, and supplies the converted power to the external device through the output, terminal; and a control unit that, when no power is supplied from the information processing device and the external device is not connected to the output terminal, drives the converter.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a block diagram of a notebook, personal computer;

FIG. 2A is a drawing that illustrates an optical disk drive as an example of a bay device;

FIG. 2B is a drawing that illustrates a bay battery as an example of the bay device;

FIG. 2C is a drawing that illustrates a bay battery including a USB charging port as an example of the bay device;

FIG. 3 is a circuit diagram that specifically illustrates the bay battery including a USB charging port;

FIG. 4 is a circuit diagram that specifically illustrates a USB device detecting circuit and a switch control circuit;

FIG. 5 is a drawing that illustrates the relations between the connection state of the bay battery including a USB charging port, the connection state of the USB device, and on and off states of each switch; and

FIG. 6 is a flowchart of controlling the bay battery including a USB charging port.

### DESCRIPTION OF EMBODIMENTS

Preferred embodiments of the present invention will be explained with reference to accompanying drawings.

The following embodiment does not limit the battery unit, the information processing device, and the method for controlling the battery unit disclosed herein.

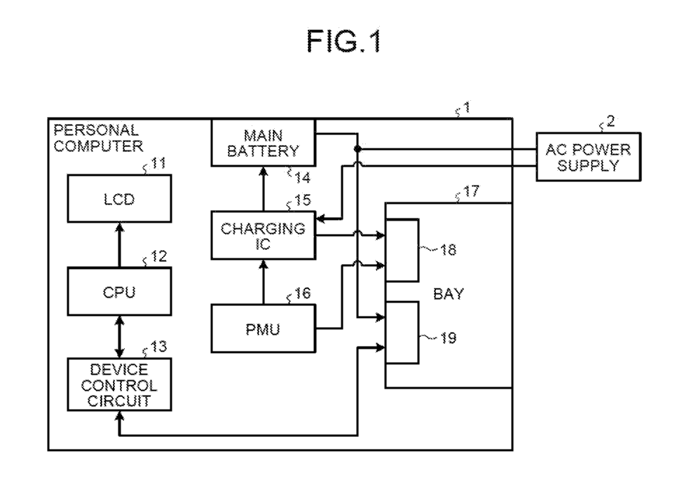

FIG. 1 is a block diagram of a notebook personal computer. The word “personal computer” collectively indicates units installed in a housing having a central processing unit (CPU) performing calculating processing.

In this embodiment, a notebook personal computer is described as an example. A personal computer 1 includes a liquid crystal display (LCD) 11, a CPU 12, a device control circuit 13, a main battery 14, a charging integration circuit (IC) 15, a power management unit (PMU) 16, and a bay 17.

The CPU 12 performs calculating processing. The CPU 12 displays a result of calculating processing and others on the LCD 11.

Examples of the device control circuit 13 include a platform controller hub (PCH). The device control circuit 13 receives and transmits commands from and to a bay device installed in the bay 17 upon instruction from the CPU 12. Installing the bay device in the bay 17 may be referred to as connecting the bay device to the personal computer 1. For example, the device control circuit 13 serves as an interface of a serial advanced technology attachment (SATA) and a USB.

The main battery 14 is a main battery to drive the personal computer 1. The main battery 14, the power supply path of which is not illustrated, supplies power to each unit of the personal computer 1.

The main battery 14 is charged by the power supplied from an AC power supply 2.

The charging IC 15 controls charging of the main battery 14 and a later-described bay battery. For example, when the charging IC 15 is instructed to charge the main battery 14 by the PMU 16, the charging IC 15 outputs power supplied from the AC power supply 2 to the main battery 14 and charges the main battery 14. Furthermore, when the charging IC 15 is instructed to charge the bay battery installed in the bay 17 by the PMU 16, the charging IC 15 outputs power supplied from the AC power supply 2 to the bay battery through a battery port 18 and charges the bay battery.

The PMU 16 generally controls the system power supply, particularly, the charging IC 15.

For example, the PMU 16 transmits an instruction to charge the main battery 14 to the charging IC 15. The PMU 16 further transmits an instruction to charge the bay battery installed in the bay 17 to the charging IC 15. The PMU 16 instructs the bay battery to switch the state between charging and power supply through the battery port 18.

The bay 17 is a space for having a bay device built therein in a manner detachable and attachable from and to the bay 17. The bay 17 is provided with the battery port 18 that supplies power for charging to a battery installed in the bay 17 as a bay device. The bay 17 is further provided with a data port 19 that supplies power to the installed bay device and receives and transmits data from and to the bay device.

The AC power supply 2 is connected with an outlet or the like and supplies power from the connected power supply to the personal computer 1. Although FIG. 1 illustrates the state where the AC power supply 2 is connected to the personal computer 1, the AC power supply 2 is attachable and detachable to and from the personal computer 1.

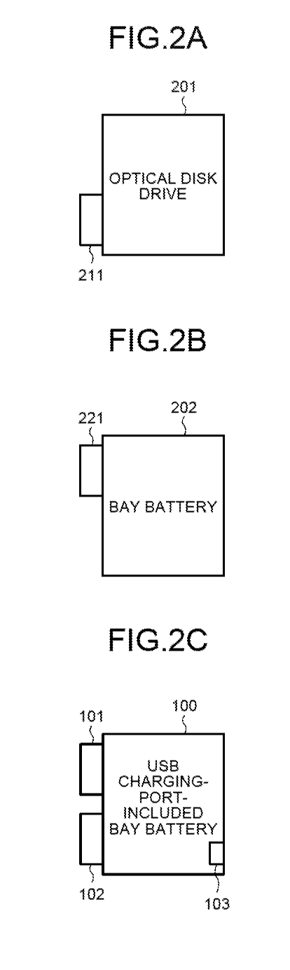

FIG. 2A is a drawing that illustrates an optical disk drive as an example of the bay device. FIG. 2B is a drawing that illustrates a bay battery as an example of the bay device. FIG. 2C is a drawing that illustrates a bay battery including a USB charging port as an example of the bay device. An optical disk drive 201 illustrated in FIG. 2A, a bay battery 202 in FIG. 2B, and others are installed in the bay 17.

The optical disk drive 201 has a port 211 connected with the data port 19 and drives upon instruction from the device control circuit 13 through the port 211. Furthermore, the optical disk drive 201 receives and transmits data from and to the personal computer 1 through the port 211 and receives power supply for driving through the port 211.

The bay battery 202 has a port 221 connected with the battery port 18 and receives a power input for charging and driving through the port 221. The bay battery 202 further receives inputs of control signals for charging and supplying power from the PMU 16 through the port 221.

In the bay 17, for example, a USB charging-port-included bay battery 100, which is one of battery units as illustrated in FIG. 2C, can be installed. The USB charging-port-included bay battery 100 has a power supply port 101, a signal port 102, and a USB port 103.

The power supply port 101 is connected with the battery port 18 of the personal computer 1 and receives power input from the charging IC 15. The power supply port 101 further receives commands for charging and supplying power from the PMU 16.

The signal port 102 is connected with the data port 19 of the personal computer 1. The signal port 102 receives input of signals from the device control circuit 13 and receives power for driving from the main battery 14 or from the AC power supply 2.

The USB port 103 is a port for connecting a USB device thereto. A mobile phone or the like is connected to the USB port 103, and the USB port 103 supplies, for example, power for charging to the connected USB device.

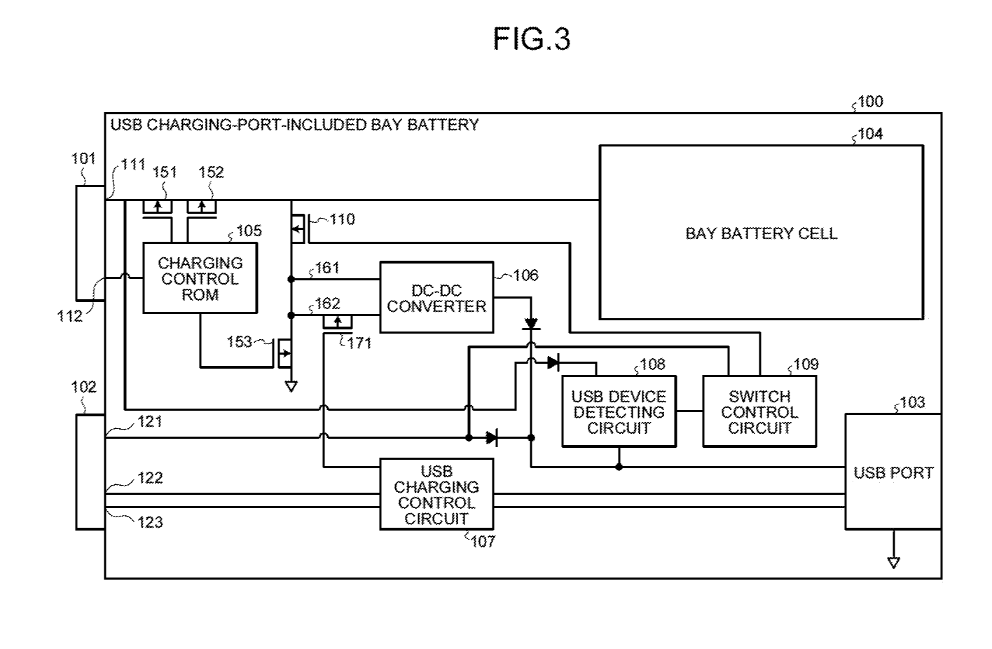

The USB charging-port-included bay battery 100 according to the embodiment will now be described with reference to FIG. 3. FIG. 3 is a circuit diagram that specifically illustrates the USB charging-port-included bay battery.

The USB charging-port-included bay battery 100 includes a bay battery cell 104, a direct current to direct current (DC-DC) converter 106, and a USB charging control circuit 107 other than the power supply port 101, the signal port 102, and the USB port 103. The USB charging-port-included bay battery 100 further includes a USB device detecting circuit 108 and a switch control circuit 109.

The power supply port 101 has a power supply terminal 111 and a signal supply terminal 112. The power supplied from the power supply terminal 111 has the same voltage as the voltage for driving the personal computer. In this embodiment, the voltage for driving the personal computer is set at 12 volts, which means that the power supplied from the power supply terminal 111 has a voltage of 12 volts.

The signal port 102 has a power supply terminal 121 and signal supply terminals 122 and 123. The power supplied from the power supply terminal 121 has the same voltage as the voltage for charging the USB device. In this embodiment, the voltage for charging the USB device is set at 5 volts, which means that the power supplied from the power supply terminal 121 has a voltage of 5 volts.

The bay battery cell 104 is a secondary battery incorporated in the USB charging-port-included bay battery 100. The bay battery cell 104 has smaller capacity than that of the main battery 14 and is connected with the power supply terminal 111 of the power supply port 101 with switches 151 and 152 interposed therebetween.

With the switches 151 and 152 turned on, the bay battery cell 104 is charged by power supplied from the AC power supply 2 through the power supply terminal 111. Specifically, the bay battery cell 104 is charged at a voltage of 12 volts, which is the voltage for driving the personal computer.

In supplying power to the personal computer 1, the bay battery cell 104 supplies 12-volt voltage power to the power supply terminal 111. In supplying power to the USB device, the bay battery cell 104 supplies 12-volt voltage power to the DC-DC converter 106.

A charging control read only memory (ROM) 105 controls the bay battery cell 104 charged by power supplied from the AC power supply 2.

The charging control ROM 105 is connected with the signal supply terminal 112 of the power supply port 101.

The charging control ROM 105 is connected with the switches 151 and 152 disposed on the power supply line connecting between the power supply terminal 111 and the bay battery cell 104. Examples of the switches 151 and 152 include a field effect transistor (FET).

The charging control ROM 105 is further connected

with a switch 153 disposed on the conveyance path connecting between the ground and the power supply line connecting between the power supply terminal 111 and the bay battery cell 104. Examples of the switch 153 include a field effect, transistor (FET).

The charging control ROM 105 receives an instruction of charging from the PMU 16 through the signal supply terminal 112. The charging control ROM 105 turns on the switches 151 and 152 by applying the gate voltage. When the bay battery cell 104 supplies power to the personal computer 1, the charging control ROM 105 receives an instruction to turn on the switches from the PMU 16 through the signal supply terminal 112. The charging control ROM 105 turns on the switches 151 and 152 by applying the gate voltage.

When the bay battery cell 104 supplies power to the USB device, the charging control ROM 105 receives an instruction to turn off the switches 151 and 152 from the PMU 16 through the signal supply terminal 112 and turns off the switches by cutting off the gate voltage.

Furthermore, when the charging control ROM 105 receives a notification that the bay battery cell 104 has run out of power from the PMU 16 through the signal supply terminal 112, the charging control ROM 105 turns on the switch 153 by applying the gate voltage. This process stops power supply from the bay battery cell 104 to the DC-DC converter 106 and the power supply terminal 111.

If the charging control ROM 105 receives no notifications that the bay battery cell 104 has run out of power from the PMU 16 through the signal supply terminal 112, the charging control ROM 105 turns the switch 153 off by cutting off the gate voltage. With this process, power is supplied from the bay battery cell 104 to the DC-DC converter 106 and the power supply terminal 111.

The DC-DC converter 106 is connected with conveyance paths 161 and 162 bifurcated from the conveyance path connecting between the ground and the power supply line connecting between the power supply terminal 111 and the bay battery cell 104.

The conveyance path 161 is a path to supply power for driving the DC-DC converter 106. The conveyance path 162 is a path to supply power to the USB device connected to the USB port 103 via the DC-DC converter 106. The power supplied to the USB device will be referred to as “charging power”. A switch 171 is disposed on the conveyance path 162. The switch 171 is an FET switch. When the switch 171 is turned on, the charging power is supplied to the DC-DC converter 106. When the switch 171 is turned off, the charging power to the DC-DC converter 106 is cut off.

A power supply switch 110 is disposed on the conveyance path connecting between the conveyance path 161 and the power supply line connecting between the power supply terminal 111 and the bay battery cell 104. When the power supply switch 110 is turned on, the charging power and driving power are supplied to the DC-DC converter 106. When the power supply switch 110 is turned off, neither the charging power nor the driving power is supplied to the DC-DC converter 106, and the DC-DC converter 106 accordingly stops driving. When the DC-DC converter 106 stops driving, no power is consumed by the DC-DC converter 106 accordingly. In this case, the power supply switch 110 is turned off with an input of a high signal and turned on with an input of a low signal.

The DC-DC converter 106 drives with power supplied through the conveyance path 161.

When the power supply switches 110 and 171 are

turned on, the charging power in a voltage of 12 volts is supplied to the DC-DC converter 106 through the conveyance path 162. The DC-DC converter 106 converts the supplied charging power from a voltage of 12 volts for driving the personal computer to 5 volts for charging the USB device. The DC-DC converter 106 outputs the charging power in 5 volts to the USB device detecting circuit 108.

The USB device detecting circuit 108 is a circuit for detecting whether a USB device is connected to the USB port 103. The USB device detecting circuit 108 outputs the result of detection of the USB device to the switch control circuit 109.

The switch control circuit 109 is a switch for controlling the power supply switch 110.

The switch control circuit 109 is connected with the power supply terminal 121 of the signal port 102. If the USB charging-port-included bay battery 100 is installed in the bay 17 of the personal computer 1, the switch control circuit 109 receives a power input from the power supply terminal 121.

The switch control circuit 109 further receives an input of the result of detection of a USB device from the USB device detecting circuit 108.

The switch control circuit 109 determines that the USB charging-port-included bay battery 100 is installed in the bay 17 of the personal computer 1 based on the power input from the power supply terminal 121 and determines that a USB device is connected to the USB port 103 based on the result of detection of the USB device. When a USB device is connected to the USB port 103 and the USB charging-port-included bay battery 100 is not installed in the bay 17 of the personal computer 1, the switch control circuit 109 turns on the power supply switch 110. When no USB devices are connected to the USB port 103 or the USB charging-port-included bay battery 100 is installed in the bay 17 of the personal computer 1, the switch control circuit 109 turns off the power supply switch 110.

Consequently, the DC-DC converter 106 stops driving and no power is consumed by the DC-DC converter 106. In summary, when no USB devices are connected to the USB port 103 or the USB charging-port-included bay battery 100 is installed in the bay 17 of the personal computer 1, the DC-DC converter 106 stops consuming power, and thus the bay battery cell 104 consumes no power.

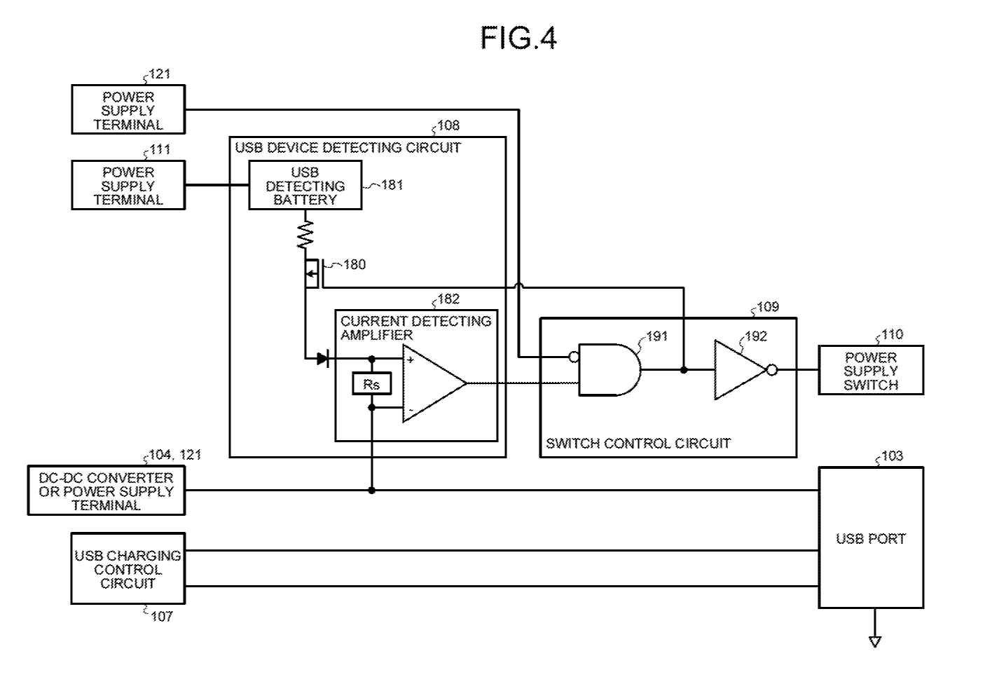

The USB device detecting circuit 108 and the switch control circuit 109 will now be described with reference to FIG. 4. FIG. 4 is a circuit diagram that specifically illustrates the USB device detecting circuit and the switch control circuit.

The USB device detecting circuit 108 includes a USB detecting switch 180, a USB detecting battery 181, and a current detecting amplifier 182.

The USB detecting battery 181 has smaller capacity than that of the bay battery cell 104. The USB detecting battery 181 needs to have capacity of power supply only enough to execute the later-described USB detecting processing.

The USB detecting battery 181 is connected with the power supply terminal 111 of the power supply port 101. When the USB charging-port-included bay battery 100 is installed in the bay 17 of the personal computer 1, the USB detecting battery 181 is charged with power supplied from the power supply terminal 111. The USB detecting battery 181 is charged at 5 volts, which corresponds to the charging voltage for the USB device.

The USB detecting battery 181 is connected with

the current detecting amplifier 182 with a resistor interposed therebetween. The USB detecting switch 180 is disposed on the power supply line connecting between the USB detecting battery 181 and the current detecting amplifier 182. Examples of the USB detecting switch 180 include an FET switch.

When the USB detecting switch 180 is on, current flows from the USB detecting battery 181 to the current detecting amplifier 182. Conversely, when the USB detecting switch 180 is off, current supplied from the USB

detecting battery 181 to the current detecting amplifier 182 is cut off.

The USB detecting switch 180 is turned on with an input of a low signal and turned off with an input of a high signal.

The current detecting amplifier 182 is implemented, for example, by a combination of a differential amplifier and a resistor as illustrated in FIG. 4. However, FIG. 4 is merely an example of the current detecting amplifier 182. Another configuration, for example, using a comparator, is applicable as long as a current flow- can be detected when a USB device is connected to the USB port 103.

The current detecting amplifier 182 receives a current input from the USB detecting battery 181.

When a USB device is connected to the USB port 103, power output from the USB detecting battery 181 is conveyed to the USB device. The current detecting amplifier 182 receives a power input from the USB detecting battery 181, When no USB devices are connected to the USB port 103, the current detecting amplifier 182 receives no power inputs from the USB detecting battery 181.

In other words, if no USB devices are connected to the USB port 103, the current detecting amplifier 182 outputs a low signal to the switch control circuit 109. Conversely, if a USB device is connected to the USB port 103, the current detecting amplifier 182 outputs a high signal to the switch control circuit 109.

For example, in the condition that no USB devices are connected to the USB port 103 and the current detecting amplifier 182 is accordingly outputting a low signal, when a USB device is connected to the USB port 103, power is supplied from the USB detecting battery 181 to the USB device. In response to this process, the current detecting amplifier 182 starts outputting a high signal to the switch control circuit 109.

The switch control circuit 109 has an AND circuit 191 and a NOT circuit 192.

The AND circuit 191 receives an input of a signal

where the logic of the output of the power supply terminal 121 is reversed. Specifically, the AMD circuit 191 receives an input of a low signal if the power supply terminal 121 outputs power and receives an input of a high signal if the power supply terminal 121 outputs no power.

The AND circuit 191 outputs a low signal upon receipt of a low signal from the current detecting amplifier 182 or from the power supply terminal 121. In other words, the AND circuit 191 outputs a low signal to the USB detecting switch 180 and the NOT circuit 192 if the USB charging-port-included bay battery 100 is connected to the personal computer 1 or no USB devices are connected to the USB port 103.

In this case, the USB detecting switch 180 is turned on. Accordingly, power is ready to be output from the USB detecting battery 181 to the USB device.

Conversely, if a USB device is connected to the USB port 103, the AND circuit 191 receives an input of a high signal from the current detecting amplifier 182. If the USB charging-port-included bay battery 100 is not connected to the personal computer 1, the AND circuit 191 receives an input of a high signal from the power supply terminal 121. In other words, the AND circuit 191 outputs a high signal to the USB detecting switch 180 and the NOT circuit 192 when a USB device is connected to the USB port 103 with the USB charging-port-included bay battery 100 connected to the personal computer 1.

In this case, the USB detecting switch 180 is turned off, which accordingly stops the output from the USB detecting battery 181 and no power is consumed by the USB detecting battery 181.

The NOT circuit 192 reverses the logic of a signal input from the AND circuit 191 and outputs the signal to the power supply switch 110. As described above, the power supply switch 110 is turned off with an input of a high signal and turned on with an input of a low signal.

More specifically, the NOT circuit 192 outputs a high signal when the USB charging-port-included bay battery

100 is connected to the personal computer 1 or when no USB devices are connected to the USB port 103. The power supply switch 110 is accordingly turned off, and the DC-DC converter 106 stops driving.

The NOT circuit 192 outputs a low signal when the USB charging-port-included bay battery 100 is connected to the personal computer 1 and a USB device is connected to the USB port 103. In this case, the power supply switch 110 is turned on. The DC-DC converter 106 accordingly starts driving, and power is supplied from the bay battery cell 104 to the USB device.

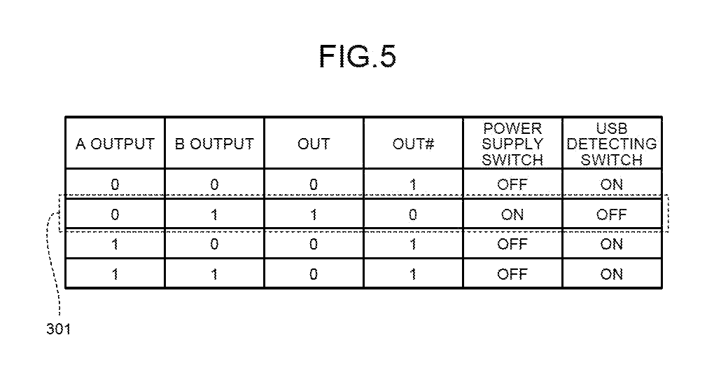

Relations between the connection state of the USB charging-port-included bay battery 100, the connection state of the USB device, and on and off states of each of the power supply switch 110 and the USB detecting switch 180 will now be generally described with reference to FIG. 5. FIG. 5 is a drawing that illustrates the relations between the connection state of the USB charging-port-included bay battery, the connection state of the USB device, and on and off states of each switch.

In FIG. 5, “A output” indicates the logic relating to an output from the power supply terminal 121, and “B output” indicates the logic relating to an output from the current, detecting amplifier 182. “OUT” in FIG. 5 indicates the logic relating to an output from the AND circuit 191, whereas “OUT#” indicates the logic relating to an output from the NOT circuit 192. Furthermore, “1” indicates a logical high value, whereas “0” indicates a logical low value.

When the USB charging-port-included bay battery 100 is not connected to the personal computer 1, the A output indicates “0”. When the USB charging-port-included bay battery 100 is connected to the personal computer 1, the A output indicates “1”. The AND circuit 191 receives a signal input with a logical value reverse to the A output.

When no USB devices are connected to the USB port 103, the B output indicates “0”. When a USB device is connected to the USB port 103, the B output indicates “1”.

As illustrated in a frame 301 indicated with a dashed line in FIG. 5, the power supply switch 110 is turned on and the USB detecting switch is turned off only when the USB charging-port-included bay battery 100 is not connected to the personal computer 1 and a USB device is connected to the USB port 103. Only with this combination, the DC-DC converter 106 drives.

In other cases, the power supply switch 110 is turned off and the USB detecting switch is turned on. In other words, the DC-DC converter 106 stops driving, and the USB device detecting circuit 108 turns to a USB-detectable state.

Referring back to FIG. 3, the USB charging control circuit 107 controls charging of a USB device connected to the USB port 103. The USB charging control circuit 107 controls switching of the USB charging-port-included bay battery 100 to a charging mode.

The USB charging control circuit 107 is connected with the signal supply terminals 122 and 123 of the signal port 102. When the USB charging-port-included bay battery 100 is connected to the personal computer 1, the USB charging control circuit 107 receives and transmits data from and to the device control circuit 13 through the signal supply terminals 122 and 123.

The USB charging control circuit 107 determines whether to switch the USB charging-port-included bay battery 100 to the charging mode. In the case of not switching to the charging mode, the USB charging control circuit 107 turns off the switch 171. Conversely, in the case of switching to the charging mode, the USB charging control circuit 107 turns on the switch 171.

The USB charging control circuit 107 transmits received data to a USB device connected to the USB port 103 according to processing on the received data.

The USB port 103 enables a USB device such as a mobile phone to be connected thereto. The USB port 103 has a port for supplying power and a port for receiving and transmitting data; and it is connected to the ground.

The port for supplying power of the USB port 103 is connected with the DC-DC converter 106 and the power supply terminal 121, and the port for receiving and transmitting data of the USB port 103 is connected with the USB charging control circuit 107.

The USB port 103 receives a power input for driving the USB device or for charging the USB device from the power supply port and supplies power to the connected USB device.

The USB port 103 receives data from the USB charging control circuit 107 through the data receiving and transmitting port and outputs the received data to the connected USB device. The USB port 103 further receives data from the connected USB device through the data receiving and transmitting port and outputs the data to the USB charging control circuit 107.

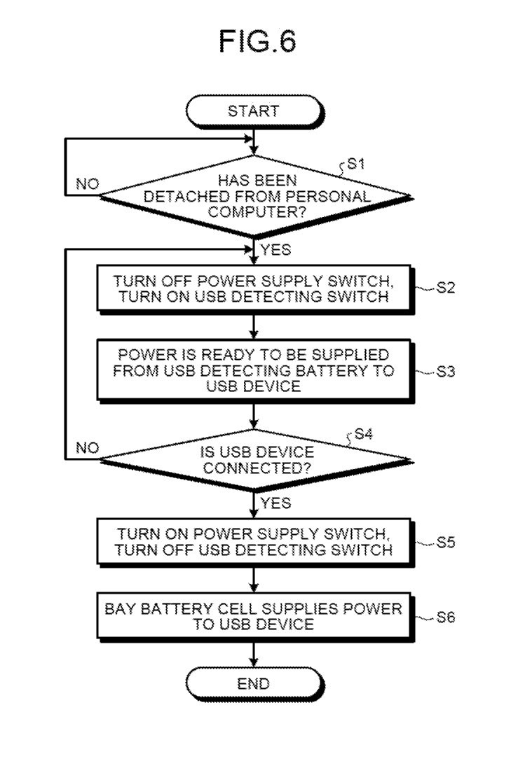

The flow of controlling the USB charging-port-included bay battery 100 according to the embodiment will now be described with reference to FIG. 6. FIG. 6 is a flowchart of controlling the USB charging-port-included bay battery. In this example, the flow starts with the USB charging-port-included bay battery 100 connected to the personal computer 1 and no USB devices connected to the USB port 103.

The switch control circuit 109 determines whether the USB charging-port-included bay battery 100 has been detached from the personal computer 1 (Step S1). If the USB charging-port-included bay battery 100 has not been detached (No at Step S1), the USB device detecting circuit 108 and the switch control circuit 109 waits for detachment of the USB charging-port-included bay battery 100 from the personal computer 1.

If the USB charging-port-included bay battery 100 has been detached (Yes at Step S1), the switch control circuit 109 turns off the power supply switch 110 and turns on the USB detecting switch 180 (Step S2).

The USB device detecting circuit 108 is accordingly ready to supply power from the USB detecting battery 181 to the USB device connected to the USB port 103 (Step S3).

The USB device detecting circuit 108 determines whether a USB device is connected to the USB port 103 based on detection of current supplied to the USB device (Step S4). If no USB devices are connected (No at Step S4), the control process for the USB charging-port-included bay battery 100 returns to Step S2.

If a USB device is connected (Yes at Step S4), the switch control circuit 109 turns on the power supply switch 110 and turns off the USB detecting switch 180 (Step S5).

The bay battery cell 104 thereafter supplies power to the USB device connected to the USB port 103 (Step S6).

As described above, the USB charging-port-included bay battery according to the embodiment drives the DC-DC converter and charges the USB device only when the USB charging-port-included bay battery is not connected to the personal computer and if a USB device is connected to the USB port.

With this configuration, the battery unit according to the embodiment can stop driving the DC-DC converter while the battery unit is not charging the USB device, which can reduce power consumption of the battery. This configuration can maintain the USB charging-port-included bay battery in a fully charged condition even when the USB charging-port-included bay battery is detached from the personal computer and can therefore efficiently charge the USB device.

Furthermore, the battery unit according to the embodiment, automatically determines the DC-DC converter to be unused based on the connection states of the battery unit and a USB device and stops driving the DC-DC converter. This configuration exerts advantageous effects in reducing power consumption of the bay battery cell 104 without depending on the operator consciously turning on and off the switch, thereby controlling an increase in the power consumption due to an error in operation.

In the above-described example, such a bay battery has been described that charges a USB device using a USB connection; however, any kind of connection is applicable between the bay battery and the device as long as the device is charged by the power of the bay battery.

According to an aspect of an embodiment, a battery unit, an information processing device, and a method for controlling the battery unit can exert advantageous effects in reducing power consumption of a battery.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A battery unit comprising:
a first battery that is charged at voltage for driving an information processing device;
an output terminal that is connectable with an external device different from the information processing device and supplies power to the external device;
a converter that receives a power input from the first battery, converts the input power into voltage for driving the external device, and supplies the converted power to the external device through the output terminal; and
a control unit that, when no power is supplied from the information processing device and the external device is not connected to the output terminal, drives the converter.

2. The battery unit according to claim 1, wherein the control unit stops driving the converter by cutting off a power input to the converter and drives the converter by allowing a power input to the converter.

3. The battery unit according to claim 1, further comprising:
a second battery that has smaller capacity than the capacity of the first battery, is charged at voltage for driving the external device, and supplies power to the external device through the output terminal, wherein
the control unit detects connection of the external device to the output terminal when the external device is connected to the output terminal and power from the second battery is supplied to the external device.

4. The battery unit according to claim 3, wherein, upon detection of connection of the external device to the output terminal, when no power is supplied from the information processing device, the control unit cuts off power supply from the second battery to the external device.

5. An information processing device, comprising:
a main battery that supplies power to the information processing device, the main battery being chargeable; and
a sub-battery unit that has smaller capacity than the main battery and supplies power to the information processing device, the sub-battery unit being attachable and detachable and being chargeable, wherein
the sub-battery unit includes:
a sub-battery that is charged at voltage for driving the information processing device;
an output terminal that is connectable with an external device that is different from the information processing device, the output terminal supplying power to the external device;
a converter that, upon receiving a power input from the sub-battery, converts the input power to voltage for driving the external device and supplies the converted power to the external device through the output terminal; and
a control unit that drives the converter when no power is supplied from the information processing device and the external device is not connected to the output terminal.

6. A method for controlling a battery unit, the method comprising:
charging a first battery at voltage for driving an information processing device; and
when an external device that is different from the information processing device is connectable and no such external devices are connected to an output terminal that supplies power to the external device with no power supplied from the information processing device, upon receiving a power input from the first battery, converting the input power into voltage for driving the external device and supplying the converted power to the external device through the output terminal.
